(19) United States
(12) Patent Application Publication
(10) Pub. No.: US 2013/0117330 A1
(43) Pub. Date: May 9, 2013

(54) RETAINING CORPORATE MEMORY

(71) Applicants: Dinesh C. Verma, New Castle, NY (US); Gopalaswamy Soora, Cary, NC (US)

(72) Inventors: Dinesh C. Verma, New Castle, NY (US); Gopalaswamy Soora, Cary, NC (US)

(73) Assignee: INTERNATIONAL BUSINESS MACHINES CORPORATION, Armonk, NY (US)

(21) Appl. No.: 13/290,688

(22) Filed: Nov. 7, 2011

(51) Int. Cl. G06F 17/30

(52) U.S. Cl. 707/803; 707/E17.005; 707/E17.044

(57) ABSTRACT

There are provided a system, a method and a computer program product for managing corporate memory. A user creates at least one rule that maps an organization scheme of electronic data in the user's individual computer to a semantic and structure of a corporate database. The system automatically transforms the electronic data in the user's individual computer to a format for storing in the corporate database according to the created rule. The system automatically uploads the transformed electronic data into the corporate database.

### BACKGROUND

The present disclosure generally relates to managing a corporate memory. More particularly, the present disclosure relates to transforming electronic data in a user's individual computer to a format for storing the electronic data in a corporate database and uploading the transformed electronic data from the user's individual to the corporate database.

In most company projects, information and knowledge obtained during the company projects are maintained in employees' brain and/or in the employees' individual computers. Employees move from one project to another, and employees do not have enough time required to store the obtained information and knowledge in a corporate database. As a result, the obtained information and knowledge are frequently lost and not stored in the corporate database. This results in a loss of corporate memory. Corporate memory refers to a set of knowledge that is retained and maintained by all the individuals of an organization or corporation.

An organization includes, but is not limited to: a company, an association, and a group that include a plurality of individuals. A function of an organization is performed by the individuals who make up the organization. For example, a service company may include several individuals who are capable of advising clients on one aspect of their technology, e.g. how to improve an operation of their computer networks. As the individuals perform different consulting services, they learn best practices and techniques that work to improve the computer networks. However, if an experienced individual leaves the service company, the knowledge and experience acquired by that experienced individual may be lost in the corporate memory of the service company as well.

In order to eliminate the loss of this corporate memory, most corporations require schemes that store the documents and other material associated with an individual's projects or other knowledge information. For example, a corporation may require that an individual leaving the corporation leaves all the documentations related to the past projects in his/her individual computer. Even when the individuals leave these documentations in his/her individual computer, those documents are rarely used and accessed by other individuals. In many instances, such documentations are left on the leaving individual's computer which is then reformatted to hand over to a new individual (e.g., a new employee). Thus, the documents and the knowledge captured in that computer are lost to the corporation upon the departure of the leaving individual.

A corporation may require that employees store all important documents into a document management system (e.g., a database in the corporation, etc.). For example, a service company may require that all service professionals upload results of a consulting project(s) to a document management system. A research organization may require that all researchers upload their research papers to a document management system. However, most employees are not diligent enough to upload the documents into the document management system. Furthermore, the uploading process is manual and requires the employees to spend significant amount of time to upload those documents. In order to improve the search-ability (i.e., a possibility that stored information can be searched) and usability of information stored in the data management system, the document management system imposes a structure and categorization in the way the information is organized. Employees frequently find creating documents to fit that structure and categorization to be time-consuming and bothersome. As a result, a very small set of documents (e.g., less than 10% of documents in an employee's computer) are uploaded to the data management system and other documents are lost upon the departure of the employee. Thus, current solutions do not provide a way to manage and retain corporate memory.

### SUMMARY OF THE INVENTION

The present disclosure describes a system, method and computer program product for managing a corporate memory.

In one embodiment, there is provided a system for managing a corporate memory. A user creates at least one rule that maps an organization scheme of electronic data in the user's individual computer to a semantic and structure of a corporate database. The system is configured to automatically transform the electronic data in the user's individual computer to a format for storage in the corporate database according to the created rule. The system is configured to automatically upload the transformed electronic data into the corporate database.

In a further embodiment, the system is configured to periodically and automatically analyze electronic data stored in the user's individual computer. The system is configured to automatically find new electronic data, among the analyzed electronic data, that have not been uploaded to the corporate database. The system is configured to automatically transform the found new electronic data according to the created rule. The system is configured to automatically upload the transformed new electronic data to the corporate database.

In a further embodiment, the electronic data include one or more of: an electronic file, an electronic document, a digital image, an electronic folder, and software.

In a further embodiment, to automatically transform the electronic data, the system is configured to one or more of: change a name of the electronic data to comply with the semantic and structure of the corporate database; match a particular electronic folder in the individual computer to a certain electronic folder in the corporate database; and change at least one characteristic of the electronic data to comply with the semantic and structure of the corporate database.

In a further embodiment, the organization scheme of the user's individual computer includes one or more of: a scheme for naming the electronic folder, a scheme for naming the electronic file, a scheme for naming the electronic document, and an individual preference for organizing the electronic document in the user's individual computer.

In a further embodiment, the system is further configured to apply the created rule to all electronic data in the user's individual computer.

In a further embodiment, the system is further configured to update the created rule.

In a further embodiment, the system is further configured to modify, by the user, the electronic data in the user's individual computer. The system is further configured to automatically detect that the electronic data is modified. The system is further configured to automatically transform the modified electronic document according to the created rule. The system is further configured to automatically upload the transformed modified electronic document from the user's individual computer into the corporate database.

In a further embodiment, the system is further configured to create, in the user's individual computer, a list of electronic data that the user want to download from the corporate database into the user's individual computer. The system is further configured to download the electronic data in the list from the corporate database into the user's individual computer. The system is further configured to transform the electronic data in the list to comply with the organization scheme of the user's individual computer. The system is further configured to store the transformed electronic data according to the organization scheme of the user's individual computer.

### BRIEF DESCRIPTION OF THE DRAWINGS

The accompanying drawings are included to provide a further understanding of the present invention, and are incorporated in and constitute a part of this specification.

FIG. 1 is a system diagram that will be deployed in a corporation in order to retain corporate memory in one embodiment.

FIG. 2 is a flow chart that describes method steps that a software agent in each user's individual computer perform to upload electronic data from the user's individual computer to a database in a corporation in one embodiment.

FIG. 3 is a system diagram of the software agent that may be installed in each user's individual computer for retaining a corporate memory in one embodiment.

FIG. 4 is a flow chart that describes method steps performed by the software agent of each user's individual computer in order to download information from the corporate memory to the user's individual computer for learning information from other users' experiences in one embodiment.

FIG. 5 illustrates an exemplary hardware configuration for implementing the flow chart depicted in FIGS. 2 and 4 in one embodiment.

### DETAILED DESCRIPTION

This disclosure describes a method, a system and a computer program product for improving a manner in which corporate information is retained and made to be more easily accessible to users (e.g., employees of a company, etc.). The method, system and computer program product are based on making at least three key observations about the way that individuals operate their personal computers:
1. Each individual usually stores information independently on his/her own individual computer (e.g., desktop, laptop, tablet computer, smart phone, netbook, etc.).
2. Each individual uses his/her own method for organizing and storing his/her information in his/her individual computer.
3. The organizing and storing method each individual uses in his/her individual computer can be mapped to a semantic and structure of a corporate database, e.g., by using rules. Examples of these rules are described below.

In one embodiment, there is provided a software agent, e.g., an application in a user's individual computer (e.g., a laptop, desktop, smart phone, tablet computer, netbook, etc.), which can automatically upload, e.g., by using File Transfer Protocol (FTP), etc., electronic data from the user's individual computer to a corporate database (e.g., IBM® DB2®, etc.) after transforming the electronic data to comply with a semantic and structure of the corporate database. The electronic data include one or more of: an electronic file, an electronic document, a digital image, an electronic folder, software, etc. A transformation of the electronic data includes, but is not limited to: changing a name of the electronic data to comply with the semantic and structure of the corporate database, matching a particular electronic folder in the individual computer to a certain electronic folder in the corporate database, changing at least one characteristic of the electronic data to comply with the semantic and structure of the corporate database. The semantic and structure of the corporate database include, but are not limited to: a hierarchy of classification of data stored in the corporate data, and a keyword associated with each electronic document which allows the electronic data to be searched.

Each user can specify rules, e.g., via an interface provided by the software agent or a computer system, that provide a mapping between an organization scheme of electronic data in the user's individual computer and the semantic and structure of the corporate database. The organization scheme of the user's individual computer includes one or more of: a scheme for naming electronic folders in the user's individual computer, a scheme for naming electronic files in the user's individual computer, a scheme for naming electronic documents in the user's individual computer, and an individual preference for organizing electronic documents in the user's individual computer.

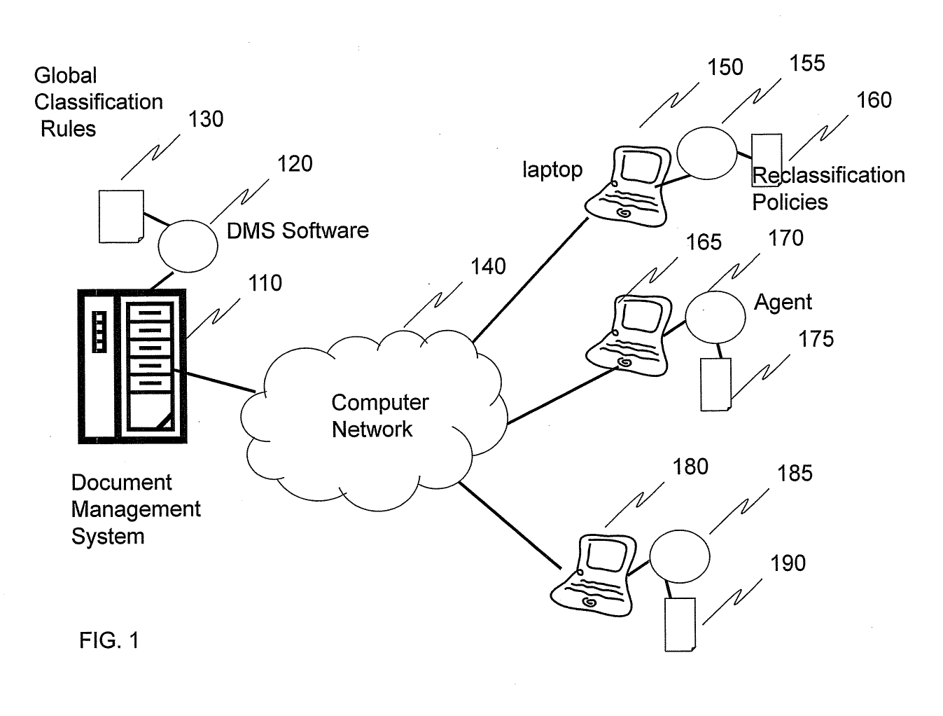

FIG. 1 illustrates an environment in which the software agent is deployed to each individual computer to automatically transform electronic data in the individual computer and then automatically upload the transformed electronic data into a corporate database in one embodiment. The software agent (e.g., software agents 155, 170 and 185) are installed in each individual computer 150, 165 or 180. The software agent allows each user to map his/her own personal organizational scheme that (s)he uses for managing electronic data in his/her individual computer to an organization convention used by a document management system software 120 (i.e., a corporate database; e.g., IBM® DB2®, etc.) installed in a document management system 110 (e.g., a workstation, a server device, etc.). Each individual computer and the document management system 110 may be connected through at least one computer network (e.g., Internet, etc.). Each user provides an initial configuration (i.e., the rules 160, 170, or 190) to the software agent, e.g., describing how his/her personal organization scheme in his/her individual computer maps onto the organization convention used by a database managed by his/her employer.

The software agent 155, 170 or 185 periodically, e.g., once per day, runs in each individual computer 150, 165 or 180 to analyze a new entry or storage of electronic data in the individual computer 150, 165 or 180, and indicates a set of new electronic data that is automatically uploaded to the data management system 110 according to rules 160, 175 or 190 (i.e., initial configuration) specified by a corresponding user. The software agent can optionally allow the user to preview the electronic data prior to its uploading in order to allow the user to modify the electronic data before the uploading. Using this software agent, managing corporate memory of documents on each user's individual computer becomes easier. The software agent reduces a burden on each individual, e.g., by automatically collecting the electronic data, automatically transforming the collected electronic data to make the electronic data comply with a semantic and structure of a corporate database, and automatically storing the transformed electronic data in the corporate database. The software agent maintains the corporate memory, e.g., by automatically storing the transformed electronic data in the corporate database.

The software agent installed in an individual computer of each individual automatically uploads electronic data that is newly created or newly received on that individual computer to the document management system. The software agent uploads the newly created electronic data after the software agent automatically transforms the newly created electronic data in the individual computer to comply with an organization convention (e.g., hierarchical classification, keywords, etc.) of the corporate document management system, e.g., by creating an entry in a hierarchical database and/or creating a keyword of the electronic data to make the electronic data be searchable. Each individual defines his/her rule on the software agent. According to the defined rule, an organization scheme in his/her individual computer is mapped to a semantic and structure of the corporate database (e.g., the document management system 110 shown in FIG. 1). Once an individual defines his/her rule on the software agent, the software agent applies the rule to all the electronic data in a corresponding individual computer. Thus, the individual does not need to create a rule per a creation of an electronic datum (e.g., an electronic file, etc.).

In one embodiment, a user creates at least one rule, in the software agent, that maps an organization scheme of electronic data in a user's individual computer to a semantic and structure of a corporate database. The software agent automatically transforms the electronic data in the user's individual computer to a format for storing in the corporate database according to the created rule. The software agent automatically uploads the transformed electronic data into the corporate database.

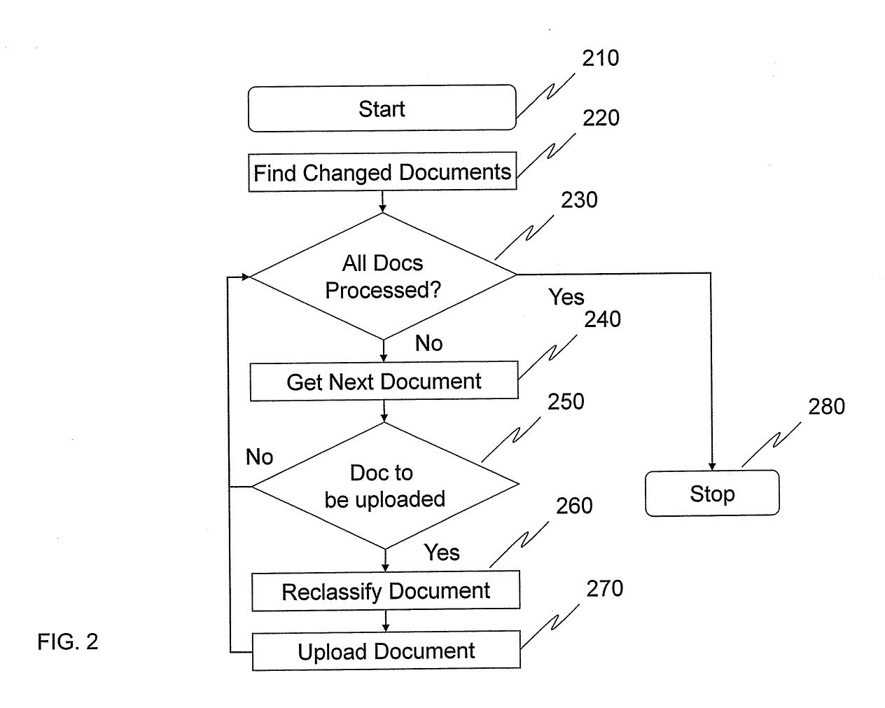

FIG. 2 is a flow chart that describes method steps run by the software agent in order to automatically upload an electronic data from an individual computer (e.g., an individual computer 150 in FIG. 1) to a corporate database (e.g., a document management system 110 in FIG. 1) in one embodiment. At step 210, a user turns on his/her individual computer where the software agent is installed. While the user is using the individual computer, the software agent is invoked or initiated to periodically and automatically analyze electronic data stored in one or more folders of the individual computer, which are associated with the created rule, without affecting the user's usage of the individual computer. At step 220, the software agent automatically finds new electronic data, among the analyzed electronic data, that have not been uploaded to the corporate database, transforms the new electronic data according to the created rule, and uploads the transformed new electronic data from the individual computer to the corporate database.

At step 230, the software agent evaluates whether all the new electronic data have been uploaded to the corporate database. If all the new electronic data have been uploaded to the corporate database, at step 280, the software agent stops running the method steps in FIG. 1. Otherwise, if there exists at least one new electronic datum that has not been uploaded to the corporate database, at step 240, the software agent retrieves the new electronic data that has not been uploaded to the corporate database. The software agent can check whether or not an electronic datum has been uploaded, e.g. by examining documents in the corporate database, or by keeping track of electronic data that have already been uploaded.

At step 250, the software agent evaluates whether the retrieved new electronic data can be uploaded to the corporate database. For example, the software agent checks whether the user is using the retrieved new electronic data or whether the user indicated the retrieved new electronic data as data that should not be uploaded to the corporate database, e.g., by specifying exceptions in the created rules on the software agent. Examples of these exceptions include, but not limited to: “if a name of a file includes “personalInfo,” then do not upload the file.” If the user is using the retrieved new electronic data or the retrieved electronic data belongs to the exceptions that describes a list of electronic data should not be uploaded, the software agent does not further process the retrieved new electronic data and returns to step 230 to start to upload another new electronic datum that has not been uploaded from the user's individual computer to the corporate database. If the retrieved new electronic data is data that can be uploaded to the corporate database, at step 260, the software agent transforms the retrieved new electronic data according the created rule, e.g., by changing a file name of the retrieved new electronic data, changing a file characteristic (e.g., file format, file size, etc.) of the retrieved new electronic data, etc. At step 270, the software automatically uploads, e.g., by using FTP, etc., the transformed new electronic data to the corporate database and repeats steps 230-270 until all the new electronic data that have not been uploaded to the corporate data are uploaded to the corporate database. The user may not know that the software agent performs steps 210-280 in his/her individual computer.

The software agent applies the created rule to all electronic data stored in the user's individual computer. The system applies the created rule to electronic data newly created in the user's individual computer. The user may update the created rule, e.g., through a user interface that the software agent provides to the user.

If a user modifies electronic data in his/her individual computer, the software agent is invoked or initiated to automatically detect that the electronic data is modified. Such a detection can be done, e.g., by comparing the time of modification of electronic data against the time that electronic data was uploaded last time. The software agent automatically transforms the modified electronic document according to the created rule. Then, the software agent initiates an automatic upload of the transformed modified electronic document from the user's individual computer into the corporate database. After the uploading, the original modified electronic document is remained in the individual computer.

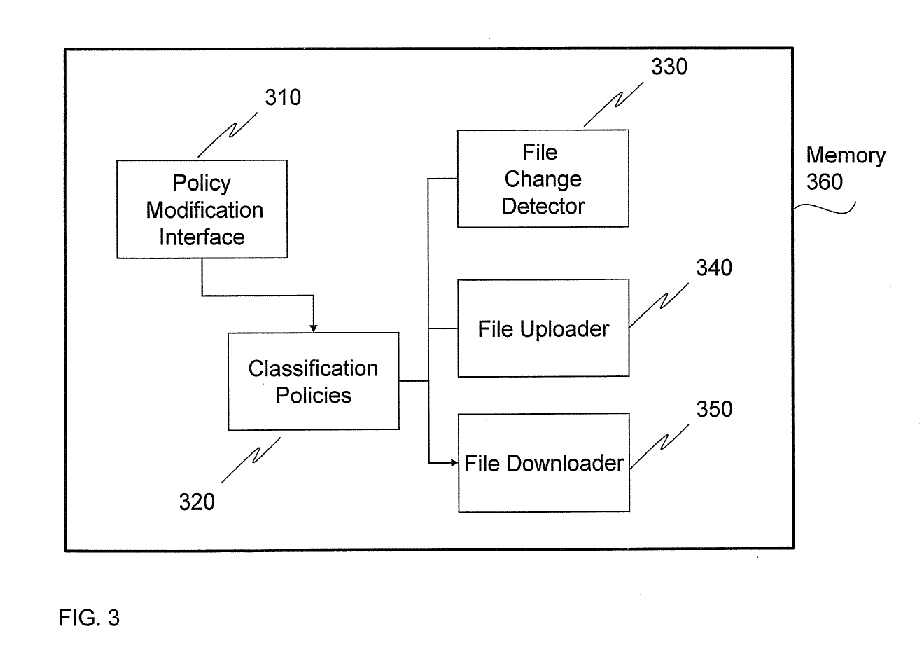

FIG. 3 is a system diagram that illustrates processing components of the software agent implemented in a memory device 360 in one embodiment. The policy modification interface component 310 allows a user to define his/her own rules, e.g., through a keyboard, mouse, touch screen, etc., to map his/her organization scheme in his/her individual computer to the semantic and structure of the corporate database. Once the user defines the rules through the interface component 310, the classification policies component 320 stores the defined rules in a local memory device (e.g., a hard disk) of the user's individual computer. Alternatively, the defined rules (e.g., rule 130 shown in FIG. 1) may be stored in a central repository, e.g., the corporate database. The corporate database may store the defined rules per each user. The file change detector component 330 periodically checks which electronic data in the user's individual computer has been modified or relocated since a last uploading of the electronic data to the corporate database. The file change detector component 330 periodically checks whether a new electronic datum is created by the user in the user's individual computer or whether a location of an electronic datum has been changed within the user's individual computer. The file change detector component 330 detects a new electronic datum created in or re-located within the user's individual computer, e.g. by comparing the creation time of an electronic datum and the last upload time of the file uploader component 340, obtaining information (e.g., last modification data of a file in the folder) from a folder including that electronic datum, by maintaining a list indicating when that electronic datum was last uploaded, or by obtaining information (e.g., file modification date, etc.) and metadata (e.g., file creation date, etc.) regarding that electronic datum and its corresponding folder that computers maintain.

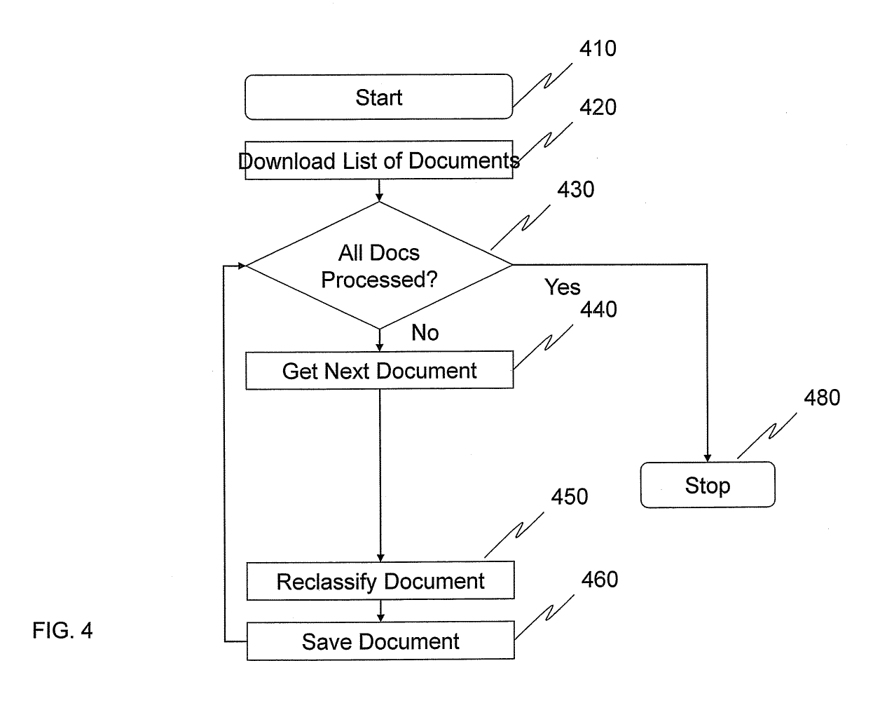

The file uploader component 340 transforms the modified electronic data and/or new electronic data according to the defined rules and uploads the transformed electronic data from the user's individual computer to the corporate database. The file downloader component 350 runs method steps in FIG. 4 to download electronic data from the corporate database to the user's individual computer.

FIG. 4 is a flow chart that describes method steps run by the file download component 350 of the software agent in one embodiment. At step 410, the software agent starts to operate the file download component 350. At step 420, the file download component 350 receives a list of electronic data that the user wants to download from the corporate database into the user's individual computer. In one embodiment, the user creates the list in his/her individual computer, e.g., by using an interface between the user and the software agent. At step 430, the file download component 350 evaluates whether all the electronic data in the list have been downloaded from the corporate database to the user's individual computer. For example, the file download component 350 may scan the user's individual computer to find whether one or more of the electronic data in the list exists in the user's individual computer. If all the listed electronic data are downloaded or existed in the user's individual computer, at step 480, the file download component 350 completes running the method steps in FIG. 4. Otherwise, at step 440, the file download component 350 may start to download the listed electronic data, which do not exist in the user's individual computer, from the corporate database the user's individual computer. At step 450, the file download component 350 transforms the listed electronic data to comply with the organization scheme of the user's individual computer. At step 460, the file download component 350 stores the transformed electronic data according to the organization scheme of the user's individual computer. The file download component 350 repeats steps 430-460 until the file download component 350 completes downloading of the listed electronic data from the corporate database to the user's individual computer.

The following describes two exemplary usage scenario of the present invention in one exemplary embodiment. These exemplary usage scenarios also describe exemplary rules that map an organization scheme of a user's individual computer to a semantic and structure of a corporate database.

An employee “A” maintains a local directory structure on his/her laptops in “My Documents” folder which forms a hierarchy structure where the first level is a company name, and the second level is a topic/type of work. Another employee “B” maintains a local directory structure which forms a folder, in “My Documents” folder, which is named by a year of an engagement and then by the name of a corresponding company. For example, the employee “A” creates a report called “Network-Optimization” in a folder like “My Documents\BXXX\NetOptimization\NetworkOptimization.doc” while the employee “B” will create a report in the directory structure “My Documents\2011\BXXX\NetOptimiz.doc.” Assume that the corporation has a keywords based indexing in the corporate database. Then, the employee “A” generates rules, for example, like:
1. The first level in the directory structure under “My Documents” is the name of company.
2. The second level in the directory structure under “My Documents” is the type of activity.

In this example, these rules map “My Documents\BXXX\NetOptimization\” folder to “Company\Bank XXX\Activity” folder in the corporate database. The software agent transmits all the files in the “My Documents\BXXX\NetOptimization\” folder to “Company\Bank XXX\Activity” folder in the corporate database with indices represented by keywords. For example, when the “NetworkOptimization.doc” file is transmitted from the employee “A” personal computer to the corporate database, the “NetworkOptimization.doc” file is named as “Network Optimization,” which is an index and keyword of this “NetworkOptimization.doc” file.

Employee B generates a rule of the nature that for his files:
1. The first level in the directory structure under “My Documents” is the year of engagement. The year portion of the date of modification of an electronic file also gives the year of the project.
2. The second level in the directory structure under “My Documents” is the name of company or client.
3. The name of an electronic file represents a type of a corresponding engagement.

In this example, these rules map “My Documents\2011\BXXX\” folder in employee “B” personal computer to “Year\2011\Company\Bank XXX\Engagements\” folder in a corporate database. The software agent transmits all the files in the “My Documents\2011\BXXX\” folder to “Year\2011\Company\Bank XXX\Engagements\” folder in the corporate database with indices represented by keywords. For example, when the “NetOptimization.doc” file is transmitted from the employee “B” personal computer to the corporate database, the “NetOptimization.doc” file is named as “Network Optimization,” which is an index and keyword of this “NetOptimization.doc” file.

Based on these rules, prior to uploading these electronic documents, the software agent creates keywords of these electronic documents, e.g., by a combination of the year of the activity, the type of the activity, the client, and/or the company. Then, prior to uploading these electronic documents, the software agent creates entries (e.g., folders), in the corporate database, corresponding to the year of the engagement, the type of the engagement, the client, and/or the company. Then, the software agent stores the electronic documents with the created keywords in the entries in the corporate database.

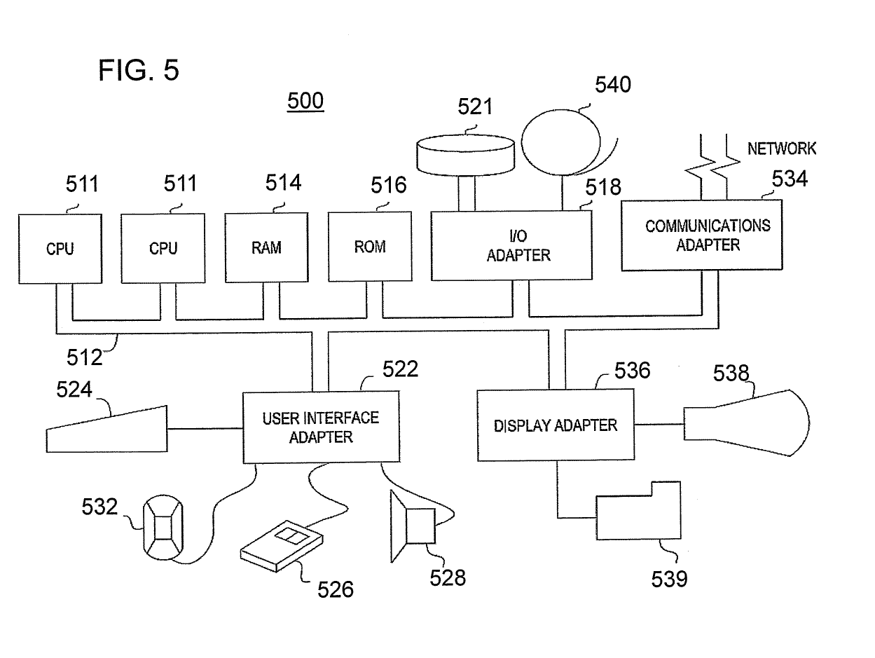

FIG. 5 illustrates an exemplary hardware configuration of the computing system 500 that implements the software agent and runs the method steps described in FIGS. 2 and 4. The hardware configuration preferably has at least one processor or central processing unit (CPU) 511. The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communication adapter 534 for connecting the system 500 to a data processing network, the Internet, an Intranet, a local area network (LAN), etc., and a display adapter 536 for connecting the bus 512 to a display device 538 and/or printer 539 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. In a further embodiment, the computing system analyzes properties of the enterprise and market social networks to build features for predictive models of a propensity for a customer to buy a product, or to close a deal in a particular period of time.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof, A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for managing a corporate memory, the method comprising:
mapping, according to at least one rule, an organization scheme of electronic data in a user's individual computer to a data classification structure of a database, the mapping rule associating a keyword with each electronic data to be stored in the database;
automatically transforming the electronic data in the user's individual computer to a format for storage in the database according to the mapping rule; and
automatically uploading the transformed electronic data into the database according to the mapping rule,
wherein a computing system including at least one memory device and at least one processor performs the step of transforming and the step of the uploading.

2. The method according to claim 1, further comprising:
periodically and automatically analyzing electronic data stored in the user's individual computer;
automatically finding new electronic data, among the analyzed electronic data, that have not been uploaded to the database;
automatically transforming the found new electronic data according to the mapping rule; and
automatically uploading, according to the mapping rule, the transformed new electronic data to the database.

3. The method according to claim 1, wherein the electronic data include one or more of: an electronic file, an electronic document, a digital image, an electronic folder, and software.

4. The method according to claim 3, wherein the step of automatically transforming includes one or more of:
changing a name of the electronic data to comply with the data classification structure of the database, matching a particular electronic folder in the individual computer to a certain electronic folder in the database, changing at least one characteristic of the electronic data to comply with the data classification structure of the database.

5. The method according to claim 3, wherein the organization scheme of the user's individual computer includes one or more of:
a scheme for naming the electronic folder, a scheme for naming the electronic file, a scheme for naming the electronic document, and an individual preference for organizing the electronic document in the user's individual computer.

6. The method according to claim 1, further comprising:
applying the mapping rule to all electronic data in the user's individual computer.

7. The method according to claim 1, further comprising:
updating the mapping rule.

8. The method according to claim 1, further comprising:
modifying, by the user, the electronic data in the user's individual computer;
automatically detecting, by the computing system, that the electronic data is modified;
automatically transforming the modified electronic data according to the mapping rule; and
automatically uploading, according to the mapping rule, the transformed modified electronic data from the user's individual computer into the database.

9. The method according to claim 1, further comprising:
creating, in the user's individual computer, a list of electronic data that the user want to download from the database into the user's individual computer;
downloading the electronic data in the list from the database into the user's individual computer;
transforming the electronic data in the list to comply with the organization scheme of the user's individual computer; and
storing the transformed electronic data according to the organization scheme of the user's individual computer.

10. A system for managing a corporate memory, the system comprising:
at least one memory;
at least one processor connected to the memory,
wherein the processor is configured to:
map, according to at least one rule, an organization scheme of electronic data in a user's individual computer to a data classification structure of a database, the mapping rule associating a keyword with each electronic data to be stored in the database;
automatically transform the electronic data in the user's individual computer to a format for storing in the database according to the mapping rule; and
automatically upload, according to the mapping rule, the transformed electronic data into the database.

11. The system according to claim 10, wherein the processor is further configured to:
periodically and automatically analyze electronic data stored in the user's individual computer;
automatically find new electronic data, among the analyzed electronic data, that have not been uploaded to the database;
automatically transform the found new electronic data according to the mapping rule; and
automatically upload, according to the mapping rule, the transformed new electronic data to the database.

12. The system according to claim 10, wherein the electronic data include one or more of: an electronic file, an electronic document, a digital image, an electronic folder, and software.

13. The system according to claim 12, wherein to automatically transform the electronic data, the processor is configured to one or more of:
change a name of the electronic data to comply with the data classification structure of the database;
match a particular electronic folder in the individual computer to a certain electronic folder in the database; and
change at least one characteristic of the electronic data to comply with the data classification structure of the database.

14. The system according to claim 12, wherein the organization scheme of the user's individual computer includes one or more of:
a scheme for naming the electronic folder, a scheme for naming the electronic file, a scheme for naming the electronic document, and an individual preference for organizing the electronic document in the user's individual computer.

15. The system according to claim 12, wherein the processor is further configured to:
apply the mapping rule to all electronic data in the user's individual computer.

16. The system according to claim 10, wherein the processor is further configured to:
update the mapping rule.

17. The system according to claim 10, wherein the processor is further configured to:
modify, by the user, the electronic data in the user's individual computer;
automatically detect that the electronic data is modified;
automatically transform the modified electronic data according to the mapping rule; and
automatically upload, according to the mapping rule, the transformed modified electronic data from the user's individual computer into the database.

18. The system according to claim 10, wherein the processor is further configured to:
create, in the user's individual computer, a list of electronic data that the user want to download from the database into the user's individual computer;
download the electronic data in the list from the database into the user's individual computer;
transform the electronic data in the list to comply with the organization scheme of the user's individual computer; and
store the transformed electronic data according to the organization scheme of the user's individual computer.

19. A computer program product for managing a corporate memory, the computer program product comprising a storage medium, wherein the storage medium is not only a propagating signal, the storage medium readable by a processing circuit and storing instructions run by the processing circuit for performing a method, the method comprising:
mapping, according to at least one rule, an organization scheme of electronic data in a user's individual computer to a data classification structure of a database, the mapping rule associating a keyword with each electronic data to be stored in the database;
automatically transforming the electronic data in the user's individual computer to a format for storage in the database according to the mapping rule; and
automatically uploading the transformed electronic data into the database according to the mapping rule.

20. The computer program product according to claim 19, wherein the method further comprises:
periodically and automatically analyzing electronic data stored in the user's individual computer;
automatically finding new electronic data, among the analyzed electronic data, that have not been uploaded to the database;
automatically transforming the found new electronic data according to the mapping rule; and
automatically uploading, according to the mapping rule, the transformed new electronic data to the database.

21. The computer program product according to claim 19, wherein the electronic data include one or more of: an electronic file, an electronic document, a digital image, an electronic folder, and software.

22. The computer program product according to claim 21, wherein the step of automatically transforming includes one or more of:
changing a name of the electronic data to comply with the data classification structure of the database, matching a particular electronic folder in the individual computer to a certain electronic folder in the database, changing at least one characteristic of the electronic data to comply with the data classification structure of the database.

23. The computer program product according to claim 21, wherein the organization scheme of the user's individual computer includes one or more of:
a scheme for naming the electronic folder, a scheme for naming the electronic file, a scheme for naming the electronic document, and an individual preference for organizing the electronic document in the user's individual computer.

24. The method according to claim 1, further comprising:
allowing a user to preview the electronic data prior to the uploading; and
allowing the user to modify the electronic data prior to the uploading.
